(19) United States
(12) Patent Application Publication
(10) Pub. No.: US 2003/0065854 A1
(43) Pub. Date: Apr. 3, 2003

(54) Method of temporarily interrupting a computer system

(76) Inventors: Daniel Bohm, Dormitz (DE); Reiner Mueller, Pinzberg (DE)

Correspondence Address: BAKER & BOTTS, 30 ROCKEFELLER PLAZA, NEW YORK, NY, 10112

(21) Appl. No.: 10/005,952

(22) Filed: Dec. 3, 2001

(30) Foreign Application Priority Data
Sep. 28, 2001 (DE) 101 48 159.4

(51) Int. Cl. G06F 9/48

(52) U.S. Cl. 710/260; 713/300

(57) ABSTRACT

The invention relates to a method of temporarily interrupting a computer system (R), with an operating system and at least one application software package being able to run on the computer system (R). In this case, software and/or software and hardware drivers which do not have idle state support are ended before introduction of the idle state (12). All the status data of the computer system (R) are recorded on a non-volatile storage device (SM), said device being prepared for the running-up of the computer system (R). The saved status data are taken into account during the system run-up (23), and the software application not supporting the idle state is reloaded and started (26).

### BACKGROUND OF THE INVENTION

In computer systems, it is usual when they are running-up for them to load a set of instructions from a BIOS (Basic Input/Output System), thereby allowing the more extensive operating system to be loaded. Once the operating system has been loaded, additional software and/or hardware drivers as well as application software can be started.

In certain operating situations of a computer system, it is advantageous to shut it down or switch it off for a short time. If, for example, in an industrial controller a system module has to be exchanged for servicing or repair, usually the controller is stopped, the system is shut down, and then the module to be changed is changed. The computer system of the industrial controller is then run-up again and, if appropriate, an application software package is started. Since system downtimes involve substantial costs, particularly in industrial applications, it is generally important to keep the downtimes as short as possible. Shortening the shutting-down and running-up times is helpful in minimizing downtimes.

U.S. Pat. No. 6,209,088 discloses putting a computer with a volatile memory and non-volatile secondary storage medium into a kind of sleeping mode, in order to shorten the system loading time significantly during a restart. In this case, the content of the processor and executable memory is stored on a secondary storage medium before the shutting down of the computer. The data are restored when the system is run-up, thereby shorten the running-up time.

Software processes which are put into a sleeping mode are known from “Tagungsband/SPS IPC Drives Nürnberg” [Conference proceedings/SPS IPC Drives Nuremberg], 10th Specialist Trade Fair and Congress, Nov. 23-25, 1999, and “Real-Time Operating System OS-9 As A Modular Integration Platform For Industrial Control, Visualization And Networking”, pages 160-171, Hütthig Verlag 1999, Heidelberg, Germany. The software processes can be awakened by a signal after a preset time.

### SUMMARY OF THE INVENTION

The object of the present invention is to provide an improved method of temporarily interrupting a computer system on which software and/or software and hardware drivers which do not have idle state support are run. This object is achieved by the following steps:

(a) generating a request for temporary interruption of the computer system by an identifying signal;

(b) ending software and/or software and hardware drivers which do not have idle state support;

(c) placing software and/or software and hardware drivers which have idle state support into the idle state;

(d) saving data describing the status of the computer system on a non-volatile storage device;

(e) preparing the non-volatile storage device for the running-up of the computer system;

(f) putting the computer system into the idle state for the temporary interruption;

(g) generating a request to discontinue the temporary interruption by means of an identifying signal after any desired time period;

(h) carrying out a computer system check before the system run-up;

(i) loading the saved status data during the system run-up;

(j) activating hardware and software drivers;

(k) activating the application software and/or at least one software service; and

(l) starting at least one software application and/or at least one software service for which there is no idle state support.

The foregoing method prevents software and/or software and hardware drivers which do not have idle state support from blocking the action of putting the computer system into the idle state. These programs and/or drivers are first ended by the system before the remaining system is put into the idle state. After running-up, these programs are again started. Consequently, a state similar to that existing before the idle state can be reestablished. A user can then also put this computer system into the idle state and significantly shorten its running-up times. The computer system and/or an operating system, and/or an operating system extension in the form of a user application, a service, or a driver has as a result of the application of the method of the present invention the authority to terminate programs in the system. The method steps (f), (i) and (k) are described in the U.S. Pat. 6,209,088.

In a preferred embodiment of the method of the invention, a software package for automation is started as the application software. Even if the automation software does not support idle state support of a computer system, the temporary interruption of the computer system can be advantageously carried out.

In a further preferred embodiment of the present invention, after the run-up, a personal-computer (PC)-based control is run on the computer system. Since personal computers (PCs) are increasingly being used for computing processes, the method can also be advantageously used for these computers.

In yet another preferred embodiment of the invention, the method is carried out on at least one machine tool, production machine or a robot (“machine”) for controlling at least one of the machines. Consequently, machine tools, production machines or robots can advantageously use the method according to the present invention, so as to support temporary interruptions. The running-up time of the computer is significantly shortened in this case, and a technical process can be made to revert to normal operation within a short time after the interruption. This leads to a cost saving for the user.

### BRIEF DESCRIPTION OF THE DRAWINGS

The present invention is explained in greater detail below in connection with an exemplary embodiment, in which:

FIG. 1 shows a schematic sequence for putting a computer system into an idle state from the operating state;

FIG. 2 shows a schematic sequence for transferring a computer system from the idle state into the operating state; and

FIG. 3 shows a symbolic representation of components of a computer system of a machine tool, production machine or a robot.

### DETAILED DESCRIPTION OF THE INVENTION

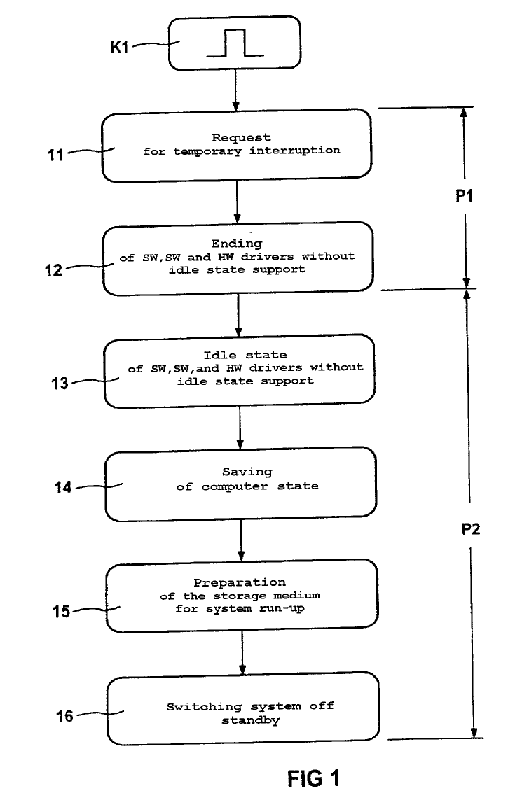

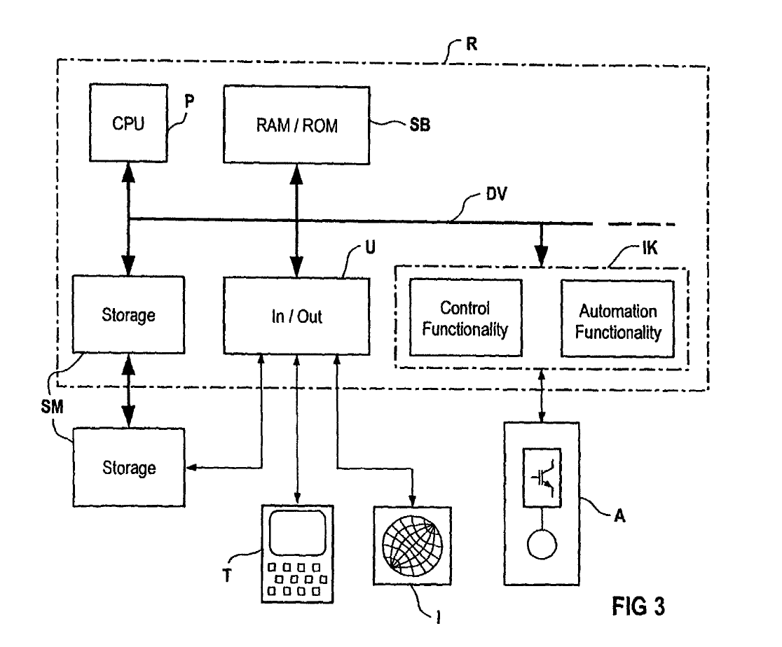

In FIG. 1, the action of putting a computer system into an idle state from the operating state is illustrated in the form of a schematic sequence. On the basis of an identifying signal K1 a request for temporary interruption 11 of the computer system R (shown in FIG. 3) is generated. In FIG. 1, logical sequences are identified by an arrow. Blocks of instructions are symbolically depicted by a rectangle with rounded corners. The identifying signal K1 may be triggered by a user instruction, a software or hardware signal, a satisfied or unsatisfied condition or by a preset inactivity time.

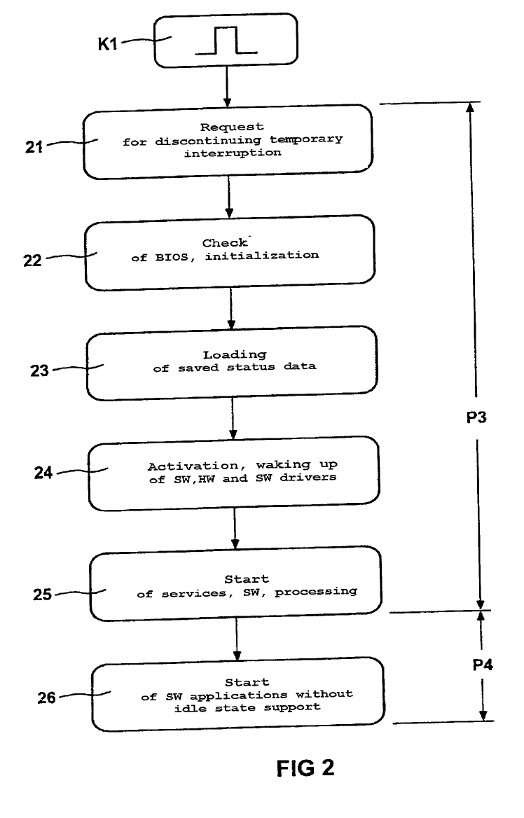

Following the request for temporary interruption 11 of the computer system R, software (SW) and/or software and hardware drivers (SW and HW) which do not have any idle state support are ended 12. To allow idle state support to be initiated for a computer system R, the programs which are incompatible with respect to the idle state are ended in a first phase P1. All the program section phases P1 to P4 are depicted in FIGS. 1 and 2 by a vertically extended double-headed arrow. The beginning and the end of the program section phases P 1 to P4 are represented by a horizontally extending line. Blocks of instructions (not shown) can be assigned to the program section phases P1 to P4.

At the beginning of the program section phase P2, the idle state for software and/or software and hardware drivers which support the idle state of the computer system is introduced 13. The idle state is in this case a state in which the control software stops its processing, but continues to occupy the required memory and the required resources. The status data of the computer are then saved 14. The backup storage medium is then prepared for the system run-up 15. Optical and magnetic data storage media may be considered for backup storage. It is also conceivable to use a volatile memory which is able to retain the data stored in it for the time period of the temporary interruption of the computer system R. For example, a commercially available DRAM may be provided with an additional power supply so that it is ensured that data are retained. Once all the status data have been stored and the system has been prepared for running-up, switching-off can be performed either automatically or by a user 16.

The method according to the present invention can be divided into two phases P1, P2 when shutting down the computer system R. In a first phase P1, incompatible software and/or software and hardware drivers are ended. In this way, it continues to be possible for the computer system R to introduce the idle state automatically. Any blocking by incompatible software components is cleared.

In automation technology, for example, it is usual to allow time-critical applications to run on computer systems R. These sometimes do not allow an idle state, since an associated technical process may possibly get into an impermissible state. Nevertheless, to be able to bring the computer system R into an idle state, the incompatible software must first be ended in a normal way. This takes place as described, in the first phase P1 of the invention.

FIG. 2 shows a schematic sequence for starting a computer R from the idle state to the operating state. The identifying signal K2 introduces a request to discontinue a temporary interruption 21. The computer system R carries out a check on the operating system and, if appropriate, an initialization 22, and further, if appropriate, detection of connected hardware. Particularly in the case of brief interruptions, this check by the computer system R can be deliberately skipped in order to save time; hence, this is at the discretion of the user and, if appropriate, can be prescribed by the user as an option.

The computer system R then loads the saved status data 23. When all the relevant data are at the storage locations which they had before the introduction of the idle state, software and/or software and hardware drivers can then be activated or awakened 24.

The application software and/or at least one software service are then activated 25. This concludes phase P3 during the running-up of the computer system R. Software applications and/or at least one software service for which there is no idle state support are then started 26. This is the run-up phase P4.

FIG. 3 provides a symbolic representation of components of a computer system R of a machine. A computer system R comprises the following components: processor P, memory device SB, storage media SM, converter U and industrial components IK. All the devices are connected via data connections DV. These are depicted by arrow connections and describe a data flow. In FIG. 3, the data connection DV ends with a broken line in the computer system R and is intended in this way to indicate that further components can be connected to the data connection DV. The computer system R itself is identified by a rectangle depicted with a broken border. Connected to the computer system R are further components, which comprise for example an external storage medium SM, a terminal T, an Internet or Intranet connection I and a drive A.

A possible use of the present invention is where a production sequence is monitored via an Internet connection I which is depicted by a rectangle with a symbolic globe in its center. In the event a fault is detected a user (not shown) stops the technical process via a terminal T. Accordingly, a drive A of a production machine is brought into a defined stopping state by means of instructions of the processor P and of the industrial components IK. The industrial components IK are indicated by a rectangle illustrated by broken lines in the computer system R, in which the symbol blocks “Control Functionality” and “Automation Functionality” are located. Here, for example, the functionality of a stored program controller and of a further automation component is executed.

Software and/or software and hardware drivers which do not have idle state support are then ended by the processor P. This could be, for example, an automation software package for the drive A.

All the data which describe the status of the computer system R and are located in the processor P or in the memory device SB are written via the data connection DV onto storage media SM. A commercially available hard disk may be mentioned here by way of example. This may be in the form of an internal or external hard disk and be connected via a converter U, represented by “IN/OUT” in a symbolic block. It is also conceivable for the hard disk to be additionally connected to the computer system R via the internal hard disk. The hard disk is then provided with system data, so that a system start from the hard disk is possible during running-up of the computer system R.

The computer system R is then put into the idle state for the temporary interruption. A user can rectify the detected fault and initiate the system run-up by a further identifying signal K1, K2 (FIGS. 1 and 2).

First, the operating system is loaded from the hard disk into the computer R before all the further status data are restored during the system run-up. Hardware and software drivers, such as drivers for the industrial components IK are then activated. Furthermore, a mail connection via Internet protocols may also be established with the Internet I. For this purpose, the connections or links existing before the idle state are reactivated. Previously running application software, such as an Internet browser program for example is similarly reactivated.

To re-establish the system state before the interruption it is then necessary to load the software applications which do not provide idle state support. In this example, it is the automation software for the industrial components IK. Once this software has been started, the technical process can be continued from the point at which the identifying signal K1 previously initiated an interruption.

Accordingly, the present invention allows even computer systems R running a software application which does not support the idle state to be put into the idle state. Previously doing so blocked the introduction of an idle state and a user had to spend time saving individual components of the system and then end them individually. Moreover, during the system run-up, time had to be spent faithfully reestablishing the previous state. The present invention overcomes these drawbacks.

We claim:

1. A method for temporarily interrupting a computer system capable of running an operating system and at least one application software package comprising the steps of
(a) generating a request for temporary interruption of the computer system by an identifying signal;
(b) ending software and/or software and hardware drivers which do not have idle state support;
(c) placing software and/or software and hardware drivers which have idle state support into the idle state;
(d) saving data describing the status of the computer system on a non-volatile storage device;
(e) preparing the non-volatile storage device for the running-up of the computer system;
(f) putting the computer system into the idle state for the temporary interruption;
(g) generating a request to discontinue the temporary interruption by means of an identifying signal after any desired time period;
(h) loading the saved status data;
(i) activating the hardware and software drivers;
(j) activating the application software and/or at least one software service; and
(k) starting at least one software application and/or at least one software service for which there is no idle state support.

2. The method according to claim 1, wherein a software package for automation is started as the application software.

3. The method according to claim 1, wherein after a run-up, a personal-computer (PC)-based control is run on the computer system.

4. The method according to claim 1, wherein the method is carried out on at least one machine for controlling said machine.

5. The method according to claim 1, further comprising carrying out a computer system check before the system run-up.
